(19) United States
(12) Patent Application Publication
(10) Pub. No.: US 2020/0084839 A1
(43) Pub. Date: Mar. 12, 2020

(54) EXTENSION OF ELECTRICALLY TRACED TUBING BUNDLES

(71) Applicant: OBCORP, LLC, St. Louis, MO (US)

(72) Inventor: John G. Kozich, Cypress, TX (US)

(21) Appl. No.: 16/566,317

(22) Filed: Sep. 10, 2019

Related U.S. Application Data
(60) Provisional application No. 62/730,156, filed on Sep. 12, 2018.

(51) Int. Cl. H05B 3/40; H02G 3/22; H01B 17/30

(52) U.S. Cl. CPC H05B 3/40; H01B 17/303; H02G 3/22

(57) ABSTRACT

An electrically traced tubing bundle includes one or more tubes and an electric heating element, encased in insulation and covered by a jacket. The heating element is given a discontinuity at a point intermediate the ends of the tubing bundle. A power extension supply wire extends from a powered end of the bundle to the discontinuity and is connected to the remote portion of the heating element. At the discontinuity, the end of the near portion of the heating element is terminated. The end of the remote portion of the heating element is terminated at the remote end of the tubing bundle.

### CROSS-REFERENCE TO RELATED APPLICATIONS

This application claims priority to U.S. Provisional Application 62/730,156, filed Sep. 12, 2018, which is hereby incorporated by reference in its entirety.

### STATEMENT REGARDING FEDERALLY SPONSORED RESEARCH

Not applicable.

### BACKGROUND OF THE INVENTION

The present invention relates to electrically traced tubing bundles. Such tubing bundles generally include one or more tubes and an electric heating element, encased in insulation and covered by a jacket.

In many applications, including off-shore platforms and many on-shore refineries, chemical plants, and the like, conduits like tubes, tubing bundles, and the like, are routed through the facility. The conduits carry not only process fluids, but also other fluids such as samples and process control fluids. The tubing is connected to numerous process monitoring, measuring, and control instruments, such as pressure and differential pressure instruments, gas analyzers, oxygen sensors, fluid temperature sensors, flow meters, and the like.

In many situations, it is desirable to protect the conduits and the instruments from adverse ambient conditions, for example to prevent freezing or congealing of the fluids in them or else to maintain the temperature of the fluid and the instrument within a predetermined range of temperatures. In those situations, the tubing and/or the instruments, or the wetted portion of the instruments, are enclosed in insulation, and may be provided with heating in the form of electrical or steam tracing.

Convenient and effective systems for insulating and heating process instruments are sold by Ametek, Inc.'s O'Brien Unit (“O'Brien/Ametek”), St. Louis, Mo., under the registered trademarks VIPAK and HEATPAK. Such systems are also described in U.S. patent application Ser. No. 16/457,420, filed Jun. 28, 2019, and owned by the owner of the present application. That application is hereby incorporated by reference.

A convenient and effective system for insulating and heating the conduit or conduits is sold by O'Brien/Ametek under the registered trademark TRACEPAK. The TRACEPAK® system is described in its bulletins QLT-TPBR (20 Jul. 2015) and QLT-OBA-BESTP (25 Apr. 2003). Such systems typically include a weather-resistant jacket, one or more tubes, a heating element, and thermal insulation between the jacket and the tubes and heating element. For convenience, the term “tubing bundle” is used herein to describe such systems, whether they include one tube or a plurality of tubes, unless the context clearly indicates a plurality of tubes. Systems using these components are described in O'Brien/Ametek bulletin QLT-OBIBR (20 May 2013).

The present invention relates to tubing bundles in which the heating element is electric. The electric heating element is generally an electric manufactured heating cable or self-regulating heat tape. The heating element is powered from an electrical source, through a circuit breaker. Typically, the power source is connected to the heating element by a power connector at one end of the tubing bundle. The system optionally includes a temperature sensor in the tubing bundle and a controller for modulating the energization of the heating element. Such tubing bundles are described, for example, in O'Brien/Ametek bulletins QLT-OBA-TRACER (20 Apr. 2014), QLT-TPKITSFLR-INT (5 Jan. 2000), and QLT-HGPAK (30 Apr. 2014).

Every electric tracer has limitations for maximum circuit length for various reasons, including primarily electrical restraints, but also practical, such as manufacturing limits, and so on. When a longer electric traced bundle length is required, a second traced circuit, with a second electric source, circuit breaker, temperature sensor, and controller must be added to the system, between the main electric source and the remote end of the tubing bundle run. This adds cost and complexity to the overall system.

### SUMMARY OF THE INVENTION

Applicant has noted that the maximum available tracer length sometimes leaves the circuit breaker with excess capacity. The present invention utilizes the excess power to extend the tube bundle length beyond traditional limitations.

In accordance with one aspect of the present invention, a method is provided for extending the circuit length of a pre-traced tubing bundle up to twice its present maximum length, the method comprising heating an extension of the tubing bundle with a heater fed by a power extension supply electrically connected to the electrical source. When the circuit length is less than twice the rated length, it is preferred to make the portion of the heater fed by the power extension source longer than the portion fed directly from the power source, so as to minimize the length of the power extension source.

In accordance with another aspect of the invention, a pre-traced tubing bundle is provided that includes a near end and a remote end, the tubing bundle comprising at least one tube, an electric heating element extending generally parallel to the at least one tube, insulation encasing the at least one tube and the electric heating element, and a jacket surrounding the insulation, the heating element, and the at least one tube, the tubing bundle further comprising a discontinuity in the heating element intermediate the ends of the tubing bundle, the discontinuity defining a near portion of the heating element and a remote portion of the heating element, and a power extension supply extending from the near end of the tubing bundle to the discontinuity and being connected to the remote portion of the heating element at the discontinuity. The relative lengths of the heaters can be chosen based on practical considerations. The near and remote portions preferably include one or more continuous tubes wrapped in continuous insulation and covered by a single jacket; any of these elements, however, may be separate pieces, connected to each other to form a continuous whole.

The present invention allows full utilization of the ampacity of the circuit breaker through which the heater is fed.

The present invention may be used with or without a temperature sensor, temperature controller, or thermostat.

The power extension supply may be interior or exterior of the jacket; if interior, its connection to the remote heater may be interior of the jacket or exterior. The near section of the heater may be grounded or otherwise terminated at the discontinuity as appropriate.

### BRIEF DESCRIPTION OF THE SEVERAL VIEWS OF THE DRAWINGS

In the accompanying drawings which form part of the specification:

FIG. 1 is a schematic view of an illustrative embodiment of an electrically traced tubing bundle in accordance with the present invention, carrying out a method of the invention.

FIG. 2 is a sectional view taken along the line 2-2 of FIG. 1.

FIG. 3 is a schematic view corresponding to FIG. 1 of a second embodiment.

### DESCRIPTION OF THE PREFERRED EMBODIMENT(S)

The following detailed description illustrates the invention by way of example and not by way of limitation. The description clearly enables one skilled in the art to make and use the invention, and describes several embodiments, adaptations, variations, alternatives, and uses of the invention, including what is presently believed to be the best mode of carrying out the invention.

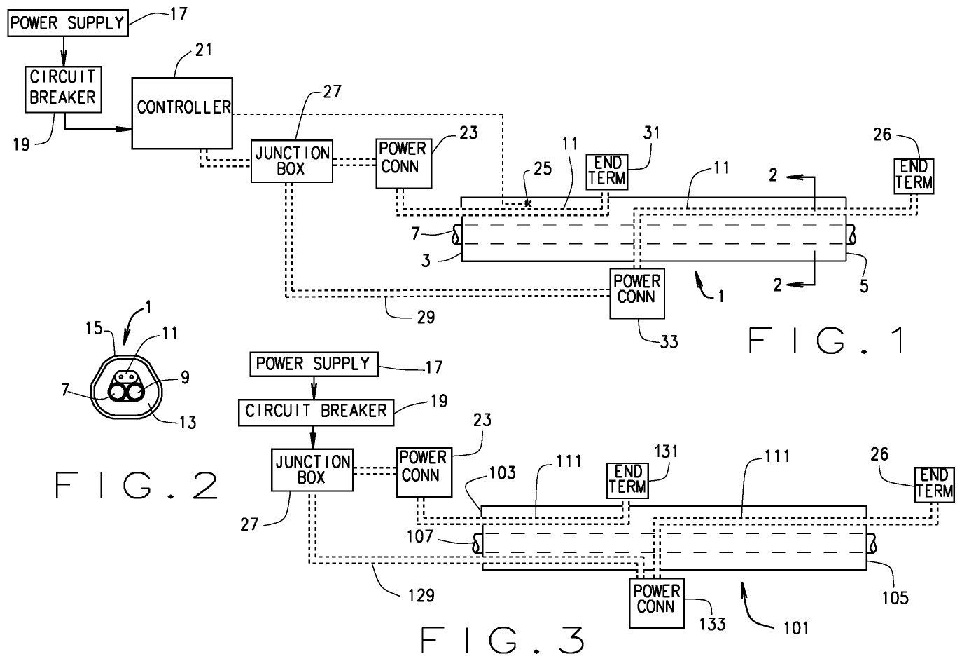

As shown in FIGS. 1 and 2, in accordance with one illustrative embodiment, a pre-traced tubing bundle 1 includes a near end 3 and a remote end 5, the tubing bundle comprising a first tube 7 and a second tube 9, an electric heating element (tracer cable) 11 extending generally parallel to the tubes 7 and 9, insulation 13 encasing the tubes 7 and 9 and the electric heating element 11, and a jacket 15 surrounding the insulation 13, the heating element 11, and the tubes 7 and 9. The heating element 11 is energized from a power supply 17 through a circuit breaker 19, a controller 21, and a power connector 23 at the near end 3 of the tubing bundle 1. A temperature sensor 25 is placed inside the insulation 13 toward the near end 3 of the bundle 1 and is connected to the controller 21 to modulate power supplied to the heating element 11 and maintain at least a desired temperature of the heater 11 and tubes 7 and 9.

In this embodiment, the tubing bundle 1 is an O'Brien TRACEPAK® SU-F3G2S-JN5/829/1 M/7-78933 sample line, commercially available from O'Brien/Ametek. As is known to those skilled in the art from this designation, the first tube 7 is a 0.375″ (9.5 mm) tube made of 316 stainless steel, the second tube 9 is a 0.25″ (6.35 mm) tube made of perfluoroalkoxy (PFA), the heater 11 is a Raychem 5VPL2-CT power limiting tracer cable, commercially available from nVent Raychem, Redwood City, Calif., and described in Tyco/Thermal Controls bulletin H56925, dated August 2007. The insulation 13 is made of fiberglass tape. The jacket 15 is made of TPU plastic. The tubing bundle 1 is designed to maintain a temperature of 60° F. (16° C.) at a low ambient design temperature of 20° F. (−7° C.). The power supply 17 provides 208-volt power through a 30-amp circuit breaker 19. The power connector 23 provides power to the tracer bus wires. The tracer cable 11 is end terminated at 26. As thus far described, the tubing bundle 1 is conventional.

The illustrative tubing bundle has a maximum published circuit length of 659 feet (201 meters). The illustrative application, however, requires a heated tubing bundle extending 829 feet (253 meters). The present invention allows extension of the bundle to this length without requiring a separate power supply and circuit breaker, or an additional controller 21 and temperature sensor 25.

In accordance with this embodiment of the invention, the power supply 17 is split at a junction box 27 into a lead connected to the power connector 23 at the near end 3 of the tubing bundle 1 and a power extension supply or “jumper” 29. The power extension supply 29 is sized according to the circuit requirements and extension length. The power extension supply 29 extends 170 feet (52 meters) along the exterior of the tubing bundle 1. The 170-foot extension supply length could be reduced if the line length is cut for installation. At that point, at least the powered conductor of the heater 11 is broken and its near end is provided with an end termination 31, which is illustratively outside the tubing bundle 1. The far end of the break in the heater conductor is attached to the power extension supply 29 by a power connection 33 extending through the jacket 15 and insulation 13. The remote 659 feet (201 meters) is heated through the power extension supply 29.

This embodiment of the invention allows the entire length of the tubing bundle to be heated with minimal modification of the bundle or its power supply.

In accordance with a second embodiment of the invention, shown in FIG. 3, a tubing bundle 101 includes tubing 107 and a tracer 111. In this embodiment, the self-regulating tracer 111 is relied upon to keep the temperature inside the tubing bundle 101 at a constant temperature, and the controller and temperature sensor are eliminated. As in the first embodiment, the tracer 111 is connected to power supply 17 through a single circuit breaker 19, a junction box 27, and a power connector 23 at a near end 103 of the tubing bundle 101. The tracer 111 is broken and the near end of the tracer 111 is connected to an end termination 131. The far end of the tracer 111 is attached through a power connector 133 to a power extension supply 129. At a far end 105 of the tubing bundle 101, the far end of the tracer 111 is connected to end terminal 26.

In this embodiment, the power extension supply 129 is encased in the insulation and jacket of the tubing bundle 101, rather than running outside the bundle. The end termination 131 and the power connector 133 are optionally encased inside the jacket of the tubing bundle 101. This arrangement requires that the entire installation be pre-engineered and custom manufactured, but produces a product with fewer external parts and potentially with fewer openings to be sealed in the bundle's jacket.

Numerous variations, within the scope of the invention, will occur to those skilled in the art.

All patents, patent applications, and literature mentioned herein are hereby incorporated by reference.

1. An electrically traced tubing bundle having a near end and a remote end, the tubing bundle comprising at least one tube, an electric heating element extending generally parallel to the at least one tube, insulation encasing the at least one tube and the electric heating element, and a jacket surrounding the insulation, the heating element, and the at least one tube, the tubing bundle further comprising a discontinuity in the heating element intermediate the ends of the tubing bundle, the discontinuity defining a near portion of the heating element and a remote portion of the heating element, and
a power extension supply extending from the near end of the tubing bundle to the discontinuity and being connected to the remote portion of the heating element at the discontinuity.

2. The tubing bundle of claim 1 wherein the power extension supply extends internally of the jacket from the near end of the tubing bundle to the discontinuity.

3. The tubing bundle of claim 1 wherein the power extension supply extends externally of the jacket from the near end of the tubing bundle to the discontinuity.

4. The tubing bundle of claim 1 wherein the heating element includes a lead extending out of the near end of the tubing bundle.

5. The tubing bundle of claim 4 wherein the lead and a near end of the power extension supply are connected to a single electric source in a junction box.

6. The tubing bundle of claim 5 wherein a single power controller controls electric power fed to the near portion and the remote portion of the electric heating element.

7. The tubing bundle of claim 1 wherein the heating element is chosen from the group consisting of self-regulating heaters, power limiting heaters, and constant power density heaters.

8. The tubing bundle of claim 1 wherein at least one of the near portion of the heating element and the far portion of the heating element has a length of at least one hundred feet.

9. The tubing bundle of claim 1 wherein both the near portion of the heating element and the far portion of the heating element have an individual length of at least ten feet.

10. A method of extending the operational length of an electrically traced tubing bundle fed from an electrical source at a near end of the tubing bundle, the method comprising heating an extension of the tubing bundle with a heater fed by a power extension supply electrically connected to the electrical source.
